(19) United States
(12) Patent Application Publication
(10) Pub. No.: US 2023/0353014 A1
(43) Pub. Date: Nov. 2, 2023

(54) ELECTRIC MOTOR CAPABLE OF QUICK SHUTDOWN

(71) Applicant: ZHEJIANG LINIX MOTOR CO., LTD., DONGYANG, Zhejiang Province (CN)

(72) Inventors: ZHONGHUA WEI, DONGYANG, ZHEJIANG PROVINCE (CN); SHAN DU, DONGYANG, ZHEJIANG PROVINCE (CN); ZHIPING ZHU, DONGYANG, ZHEJIANG PROVINCE (CN); LEI ZHANG, DONGYANG, ZHEJIANG PROVINCE (CN); KAILE REN, DONGYANG, ZHEJIANG PROVINCE (CN)

(21) Appl. No.: 18/025,903

(22) PCT Filed: Nov. 17, 2021
(86) PCT No.: PCT/CN2021/131049

§ 371 Date: Mar. 12, 2023

(30) Foreign Application Priority Data
Nov. 20, 2020 (CN) 202011315333.5

(51) Int. Cl. H02K 7/106; H02K 7/08; H02K 5/173

(52) U.S. Cl. CPC H02K 7/106; H02K 7/083; H02K 5/1732

(57) ABSTRACT

The present invention relates to a motor, in particular to a motor allowing for quick shutdown. A motor allowing for quick shutdown includes an enclosure, an end cover, a rotor, a magnet ring and a metal ring. The metal ring is made of permanent magnet material, and the magnet ring and the metal ring are adjacent to each other and can interact magnetically with each other. Several magnetic poles, of which N poles and S poles are staggered in the circumferential direction of the magnet ring, are formed on adjacent end faces or circumferential surfaces of the magnet ring and the metal ring. One of the magnet ring and the metal ring is coaxially fixed to the rotor, while the other one is fixed to the enclosure or the end cover. The present invention has the advantages that there is no dust caused by friction, which can effectively avoid the risk of motor jammed or shortened service life, and the motor can achieve quick shutdown and output a constant magnetic damping torque when in use.

### TECHNICAL FIELD OF THE INVENTION

The present invention relates to a motor, in particular to a motor that can be quickly shut down.

### BACKGROUND OF THE INVENTION

The Chinese patent No. 201910494172 0.1 discloses a motor allowing for quick shutdown, which damps a rotor shaft by a compression spring and other mechanical structures to reduce the speed of a rotor after the motor is powered off, so as to stop the rotor and then shut down the motor quickly. However, the above solution has the following defects. The compression spring and other mechanical structures will produce noise when rotating, and the compression spring and other components will produce debris and dust due to abrasion, with the risk of components jammed and shortened service life of the motor. At the same time, with the continuous abrasion of the compression spring and other components, the damping torque will gradually decrease with time, so it is hard to achieve quick shutdown after the motor is powered off.

### SUMMARY OF THE INVENTION

An object of the present invention is to provide a low-noise motor allowing for quick shutdown, which can prevent components therein from being jammed.

To achieve the above object, a technical solution employed in the present invention is as follows. A motor allowing for quick shutdown is provided, comprising an enclosure, an end cover, a rotor, a magnet ring and a metal ring, wherein the metal ring is made of permanent magnet material, and the magnet ring and the metal ring are adjacent to each other and can interact magnetically with each other; several magnetic poles, of which N poles and S poles are staggered in the circumferential direction of the magnet ring, are formed on adjacent end faces or circumferential surfaces of the magnet ring and the metal ring; and one of the magnet ring and the metal ring is coaxially fixed to the rotor, while the other one is fixed to the enclosure or the end cover.

When the motor is in use, the magnet ring will magnetize the metal ring made of permanent magnet material, so that the magnetic poles attracted to the magnet ring are formed on the end face or circumferential surface of the metal ring near the magnet ring. A constant magnetic damping torque can continuously exist between the metal ring and the magnet ring when the magnet ring rotates, so as to increase the force required for rotor rotation, reduce the speed of the rotor, and shut down the motor quickly after the power is cut off.

The motor in the present invention is of a magnetic damping structure and will produce no mechanical friction when in use, so no noise will be generated, which can achieve the effect of low-noise or even silent. There is no dust caused by friction, which can effectively avoid the risk of motor jammed or shortened service life. At the same time, the magnet ring keeps magnetizing the metal ring when rotating, so the metal ring made of permanent magnet material is magnetized to have the same number of pole pairs as the magnet ring. However, the number of magnetic poles on the metal ring varies as the magnet ring rotates, so that the motor can output a constant magnetic damping torque to keep still under the action of external force (such as gravity, and spring force of a mechanism) after the power is cut off, without any load slip or reverse slip on the rotor.

Preferably, the magnet ring and the metal ring are sleeved with each other, and the magnetic poles are formed on the circumferential surface of the magnet ring. The magnet ring is located on an outer or inner circumferential side of the metal ring, allowing a smaller axial size of the motor and thus a smaller motor.

Preferably, the magnet ring and the metal ring are spaced in the axial direction of the rotor, and the magnetic poles are formed on the end face of the magnet ring. The magnet ring is located at one circumferential side of the metal ring, allowing for a smaller motor.

Preferably, an axis of the magnet ring basically coincides with that of the metal ring. With the above arrangement, the motor in the present invention is more stable in structure and in use and has a longer service life, without any vibration and noise.

Preferably, the axis of the metal ring deviates from that of the magnet ring. With the above arrangement, the magnetic resistance is enhanced when in use of the motor in the present invention to make the effect of quick shutdown more obvious.

Preferably, a hold-down groove, in which one of the magnet ring and the metal ring is fixed, is formed on an inner side of the end cover. The one fixed in the hold-down groove of the end cover can be made smaller to facilitate its positioning and fixation. By fixing one of the magnet ring and the metal ring in the hold-down groove on the end cover, less space inside the motor will be occupied, without affecting the layout of other motor components.

Preferably, a bearing housing for securing a bearing is formed on the inner side of the end cover, the stepped hold-down groove is provided at an opening of the bearing housing, and a rotor shaft of the rotor is rotatably fixed to the end cover through the bearing. The hold-down groove is provided at the opening of the bearing housing to facilitate the fixation and positioning of the magnet ring or the metal ring, and the magnet ring or the metal ring may be tightly fitted in the hold-down groove, and may also be fixed in the hold-down groove by glue. The magnet ring or the metal ring fixed in the hold-down groove should have an inner diameter larger than an outer diameter of the bearing, and will not interfere with components of a rotor core.

Preferably, one of the magnet ring and the metal ring is fixed to the rotor shaft of the rotor. The magnet ring or the metal ring fixed to the rotor shaft can be made smaller in inner diameter to make the rotation more stable.

Preferably, a connecting ring is fixed outside the rotor shaft, and the magnet ring or the metal ring is fixed to an end face or a circumferential surface of the connecting ring. One of the magnet ring and the metal ring is fixed to the rotor shaft through the connecting ring, which allows for less consumables, lower costs, and more stable fixation of the magnet ring or the metal ring. The connecting ring can be made of aluminum, copper and iron, and can be made into various shapes. The magnet ring or the metal ring may be fixed to a circumferential surface or an axial end surface of the connecting ring.

Preferably, the connecting ring is made of magnetic conductive material. The connecting ring is made of magnetic conductive material to enhance the magnetic torque between the magnet ring and the metal ring, so as to improve the effect of quick shutdown.

The present invention has the advantages that there is no dust caused by friction, which can effectively avoid the risk of motor jammed or shortened service life, and the motor can allow quick shutdown and output a constant magnetic damping torque when in use so that it can keep still under the action of external force (such as gravity, and spring force of a mechanism) after power failure, without any load slip or reverse slip on the rotor.

### BRIEF DESCRIPTION OF THE DRAWINGS

FIG. 1 is a structural diagram according to Embodiment 1 of the present invention;

FIG. 2 is a structural diagram according to Embodiment 2 of the present invention;

FIG. 3 is a structural diagram according to Embodiment 3 of the present invention; and

FIG. 4 is a damping characteristic diagram in use of the present invention.

### DETAILED DESCRIPTION OF THE INVENTION

The present invention will be further described as below with reference to the accompanying drawings by specific embodiments.

### Embodiment 1

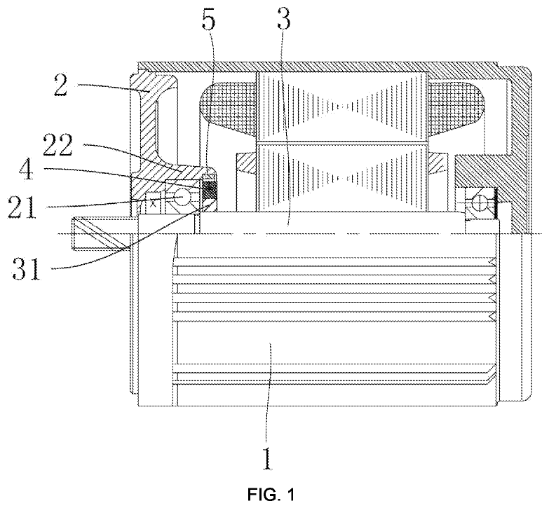

As shown in FIG. 1, a motor allowing for quick shutdown in the present invention comprises an enclosure 1, an end cover 2, a magnet ring 4, and a metal ring 5. A rotor having a rotor shaft 3 is rotatably fixed in the enclosure 1, the metal ring 5 is made of permanent magnet material, and the magnet ring 4 and the metal ring 5 are adjacent to each other and can interact magnetically with each other. Several magnetic poles, of which N poles and S poles are staggered in the circumferential direction of the magnet ring 4, are formed on adjacent circumferential surfaces of the magnet ring 4 and the metal ring 5. one of the magnet rings 4 and the metal ring 5 are coaxially fixed to the rotor, while the other one is fixed to the end cover 2.

The magnet ring 4 is coaxially fixed to the rotor shaft 3 of the rotor, and the metal ring 5 fixed to the end cover 2 is fixed in the enclosure 1. The magnet ring 4 and the metal ring 5 are sleeved with each other, wherein an axis of the metal ring 5 basically coincides with that of the magnet ring 4, and the metal ring 5 is sleeved on an outer circumferential side of the magnet ring 4. The metal ring 5 is made of permanent magnet alloy, and the magnet ring 4 is made of NdFeB.

A bearing housing 22 for securing a bearing 21 is formed on an inner side of the end cover 2, and a stepped hold-down groove is provided at an opening of the bearing housing 22. The rotor shaft 3 of the rotor is rotatably fixed to the end cover 2 through the bearing 21, and the metal ring 5 is fixed in the hold-down groove.

The magnet ring 4 is fixed to the rotor shaft 3 of the rotor through a connecting ring 31, the connecting ring 31 made of magnetic conductive material is fixed outside the rotor shaft 3, and the magnet ring 4 is fixed to a circumferential surface of the connecting ring 31.

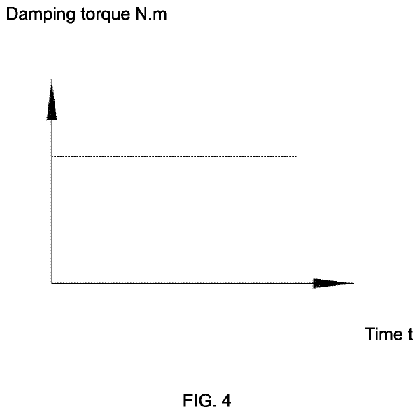

As shown in FIG. 4, the magnet ring 4 keeps magnetizing the metal ring 5 when rotating, so the metal ring 5 made of permanent magnet alloy is magnetized to have the same number of pole pairs as the permanent magnet ring 4. As the magnet ring 4 rotates, the damping torque remains stable with time, and the metal ring 5 can keep a constant magnetic damping torque in this process.

### Embodiment 2

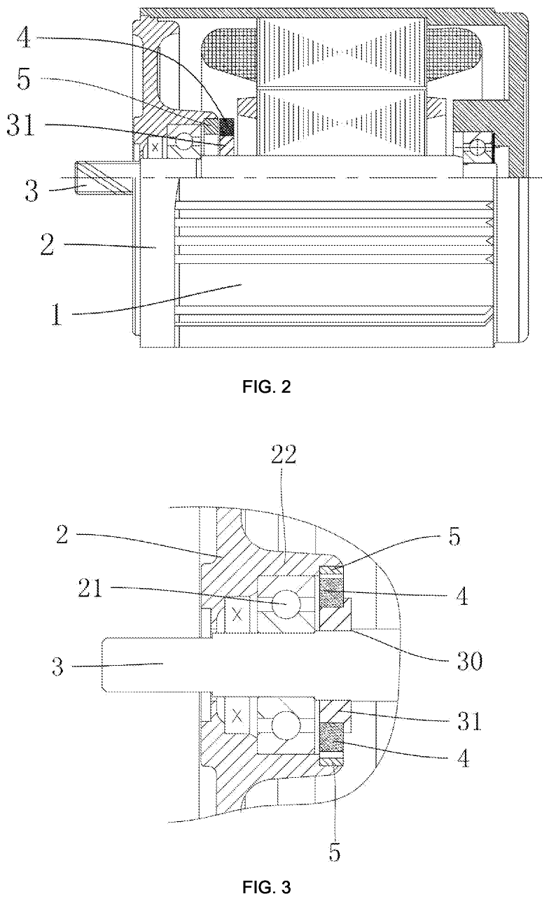

As shown in FIG. 2, the difference between this embodiment and Embodiment 1 lies in that the magnet ring 4 and the metal ring 5 are spaced in the axial direction of the rotor, the magnetic poles are formed on an end face of the magnet ring 4, and there is an annular coincident face between the end face of the magnet ring 4 and the end face of the metal ring 5 after being projected in the axial direction of the rotor shaft.

### Embodiment 3

As shown in FIG. 3, the difference between this embodiment and Embodiment 1 lies in that the metal ring 5 has the same circumferential width, and the axis of the metal ring deviates from that of the magnet ring 4. The connecting ring 31 is of a stepped structure, the rotor shaft 3 is provided with a stepped bulge 30 for confining the connecting ring 31, the connecting ring 31 to which the magnet ring 4 is tightly fitted, is tightly fitted to the rotor shaft. The connecting ring 31 is made of magnetic conductive material (optionally iron).

The advantages of the present invention are as follows. \textcircled{1} The motor in the present invention is of a magnetic damping structure and will produce no mechanical friction when in operation, so no mechanical noise will be generated, which can achieve the effect of completely low-noise or even completely silent, and enhance the use experience of the motor. \textcircled{2} There is no dust caused by friction, which can effectively avoid the risk of motor jammed or shortened service life. \textcircled{3} The motor can output constant damping torque to allow the long-term stable operation, and is suitable for occasions wherein the motor is required to keep still under the action of external force (such as gravity, and spring force of a mechanism) after the power is cut off, without any load slip or reverse slip on the rotor.

1. A motor allowing for quick shutdown, comprising an enclosure, an end cover, a rotor, a magnet ring and a metal ring, wherein the metal ring is made of permanent magnet material, and the magnet ring and the metal ring are adjacent to each other and can interact magnetically with each other; several magnetic poles, of which N poles and S poles are staggered in the circumferential direction of the magnet ring, are formed on adjacent end faces or circumferential surfaces of the magnet ring and the metal ring; and one of the magnet ring and the metal ring is coaxially fixed to the rotor, while the other one is fixed to the enclosure or the end cover.

2. The motor allowing for quick shutdown according to claim 1, wherein the magnet ring and the metal ring are sleeved with each other, and the magnetic poles are formed on the circumferential surface of the magnet ring.

3. The motor allowing for quick shutdown according to claim 1, wherein the magnet ring and the metal ring are spaced in the axial direction of the rotor, and the magnetic poles are formed on the end face of the magnet ring.

4. The motor allowing for quick shutdown according to claim 1, wherein an axis of the magnet ring basically coincides with that of the metal ring.

5. The motor allowing for quick shutdown according to claim 1, wherein the axis of the magnet ring deviates from that of the metal ring.

6. The motor allowing for quick shutdown according to claim 1, wherein a hold-down groove, in which one of the magnet ring and the metal ring is fixed, is formed on an inner side of the end cover.

7. The motor allowing for quick shutdown according to claim 1, wherein a bearing housing for securing a bearing is formed on the inner side of the end cover, the stepped hold-down groove is provided at an opening of the bearing housing, and a rotor shaft of the rotor is rotatably fixed to the end cover through the bearing.

8. The motor allowing for quick shutdown according to claim 1, wherein one of the magnet ring and the metal ring is fixed to the rotor shaft of the rotor.

9. The motor allowing for quick shutdown according to claim 8, wherein a connecting ring is fixed outside the rotor shaft, and the magnet ring or the metal ring is fixed to an end face or a circumferential surface of the connecting ring.

10. The motor allowing for quick shutdown according to claim 9, wherein the connecting ring is made of magnetic conductive material.
